(19) United States
(12) Patent Application Publication
(10) Pub. No.: US 2009/0217313 A1
(43) Pub. Date: Aug. 27, 2009

(54) WEB SERVICE REGISTING SYSTEM WITH SERVICE EVALUATION AND UTILITY KNOWLEDGE

(75) Inventors: Ing Yi CHEN, Taipei City (TW); Jonathan Lee, Taipei City (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: NATIONAL CENTRAL UNIVERSITY, Taoyuan County (TW)

(21) Appl. No.: 12/051,553

(22) Filed: Mar. 19, 2008

(30) Foreign Application Priority Data
Feb. 27, 2008 (TW) 097106737

(51) Int. Cl. G06F 9/46

(52) U.S. Cl. 719/330

(57) ABSTRACT

A web service registering system with service evaluation and utility knowledge is disclosed. The system includes a service interface, a database, a UDDI service register machine and a core integrating module. A service user can generate a function calling message corresponding to a target service of a service provider via the service interface. A service evaluation and a utility knowledge corresponding to the target service are stored in the database. The web service registering system generates integration information by integrating the service evaluation, the utility knowledge, and the target service via the core integrating module according the function calling message and connecting the function service of the UDDI service register machine. Then, the web service registering system shows the integration information on the service interface.

### BACKGROUND OF THE INVENTION

1. Field of the invention

The invention relates to a web service registering system, and more particularly, to a web service registering system with service evaluation and utility knowledge.

2. Description of the prior art

In the present information society, the internet has become a necessary part of conventional information service system. Providing service through internet is a developing trend at present. For example, the service-oriented architecture (SOA) is an architecture developed based on this trend.

The SOA connects various services provided by different enterprises via the technology of internet service. The SOA includes a service provider, a service user, and a service mediator. The service mediator is a common platform between the service user and the service provider. With the help of this common platform, the service provider can provide the service information, and the service user can acquire the service information to drive the operation of this architecture.

In the present SOA, the most often used service mediator is a universal description, discovery and integration (UDDI) service registering system. The UDDI service registering system provides a set of standards for describing and discovering services and a set of practical methods based on the internet The service user can exchange the service information on the UDDI service registering system via the functions of service registering, service searching (keywords), and service browsing.

The UDDI information architecture includes four core information elements: business entity, business service, binding template, and t-model. The business entity stores the information related to the provider (e.g., the enterprise) to establish the business information model. The business service is the information describing the service. The binding template is used for establishing the corresponding relation between the business service and t-model. And the t-model is the service technology information (e.g., WSDL).

The information access in the UDDI service registering system is performed via the universal unique identification (UUID). The UUID is a 16-bit string. When the service provider provides a service, the UDDI service registering system will automatically generate a set of UUID and distribute the set of UUID to the service. The service user can search and browse the information of the service based on the UUID corresponding to the service.

In practical applications, the process of using the internet service by the service user can be divided into three stages: service selecting, service acquiring, and service using. Although the service user can acquire the service information via the function of UDDI service registering system, the information provided by the UDDI service registering system cannot show the quality of the service at the stage of selecting service,. Therefore, it is hard for the UDDI service registering system to assist the service user in judging the service and selecting a better service from the various services.

In addition, after the service user acquires the service information smoothly, he/she will move to the stage of using service. However, the information provided by the present UDDI service registering system cannot provide the service user the utility knowledge related to the service. Therefore, it is hard for the UDDI service registering system to help the service user become familiar with the service effectively and use the service smoothly.

In conclusion, in the process of using the internet service, the conventional UDDI service registering system can meet the basic requirement of the service user when acquiring the service; however, the UDDI service registering system cannot provide helpful information to help the service user select or use the service effectively. Namely, it is insufficient for the service user.

Therefore, the invention provides a web service registering system with service evaluation and utility knowledge to solve the above-mentioned problems.

### SUMMARY OF THE INVENTION

A scope of the invention is to provide a web service registering system with service evaluation and utility knowledge. An embodiment according to the invention is a web service registering system. The web service registering system comprises a service interface, a database, a UDDI service registering machine, and a core integrating module.

A service user can generate a calling message via the service interface. The calling message corresponds to a target service provided by a service provider. The database stores a service evaluation and a utility knowledge corresponding to the target service. The UDDI service registering machine is used for responding the calling message and acquiring the target service.

The core integrating module is connected to the service interface, the database, and the UDDI service registering machine. And the core integrating module is used for accessing the service evaluation and the utility knowledge from the database according to the calling message and generating integrated information by integrating the service evaluation, the utility knowledge and the target service. Then, the integrated information is displayed on the service interface.

Compared to the prior art, the web service registering system according to the invention has the functions of service evaluation and utility knowledge. Thus, the service user can acquire the needed service information via the web service registering system. When the user wants to select service, the service evaluation provided by the web service registering system according to the invention can be used for selecting a better service from the various services. In addition, the service user can use the service quickly and smoothly with the help of utility knowledge provided by the web service registering system.

The advantage and spirit of the invention may be further understood by the following recitations together with the appended drawings.

### BRIEF DESCRIPTION OF THE APPENDED DRAWINGS

FIG. 1 is a functional block diagram of the web service registering system of an embodiment according to the invention.

FIG. 2 is a detailed functional block diagram of the web service registering system shown in FIG. 1.

FIG. 3 is a detailed functional block diagram of the web service registering system shown in FIG. 2.

FIG. 4(A) shows the connection between the keywords and the service in the example; FIG. 4(B) shows the method of recording the keyword information; and FIG. 4(C) shows the keyword information shown on the service interface.

FIG. 5(A) shows the connection between the service user and the service in an example; FIG. 5(B) shows the state of the user related to the service A; FIG. 5(C) shows the service using state related to the service user Alice; and FIG. 5(D) shows the state of the user related to the service B.

### DETAILED DESCRIPTION OF THE INVENTION

The invention provides a web service registering system with service evaluation and utility knowledge to meet the requirement of the service user when he/she selects the service or uses the service.

The web service registering system must have a service mediating function to connect the both sides of the service user and the service provider. Thus, the web service registering system provided by the invention combines the UDDI architecture to meet this requirement. By calling the application program interface (API) of the UDDI, the web service registering system can provide the functions of UDDI service registering, service searching, and service browsing. The service provider and the service user can register on the web service registering system and acquire the service information to finish the transmission of the service information.

In the web service registering system provided by the invention, the access of information is performed based on a 16-bit UUID string. When the service provider wants to provide a service, the web service registering system will automatically generate a set of UUID strings and distribute the set of UUID strings to the service. At this time, the service user can search and browse the information related to the service based on the UUID strings corresponding to the service. Then, by recording the connection between the UUID strings and the information generated by the service function, the web service registering system can establish the corresponding relationship between them to expand the function and information of the UDDI.

For example, when a service user wants to select a service from the various services, the user can consult the former service evaluations about the service quality made by other users to select a better service by means of the function of service evaluation provided by the web service registering system of the invention. Furthermore, after the service user uses the service, the user can also evaluate the service based on his/her using experience. The web service registering system according to the invention will collect all service evaluations provided by the service users to give a reference for the potential users selecting the service. Because the information type of the service evaluation and the utility knowledge can be characters or values, the UUID strings must be recorded in these data to establish the connection between the service evaluation and the utility knowledge, and then the integrated service of the invention and UDDI can be provided.

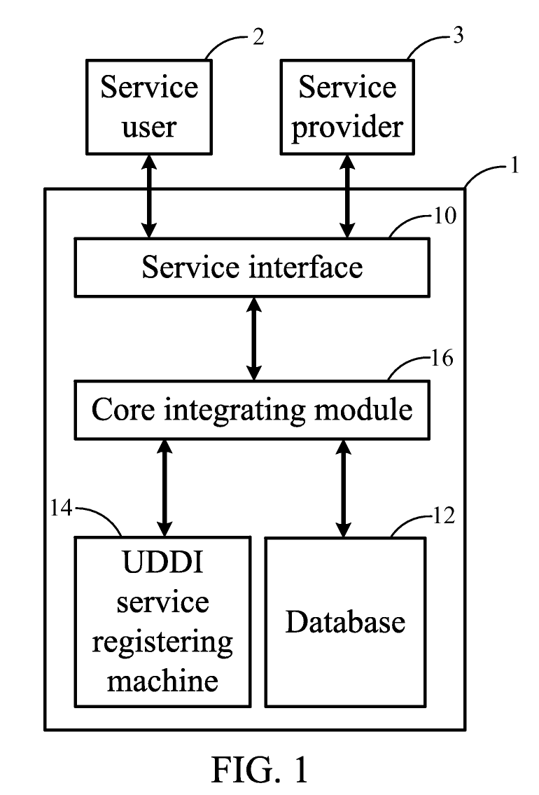

An embodiment based on the invention is a web service registering system. Please refer to FIG. 1. FIG. 1 shows the functional block diagram of the web service registering system. As shown in FIG. 1, the web service registering system 1 comprises a service interface 10, a database 12, a UDDI service registering machine 14, and a core integrating module 16.

A service user 2 can generate a calling message via the service interface 10. The calling message corresponds to a target service provided by a service provider 3. The database 12 stores a service evaluation and a utility knowledge corresponding to the target service. And, the UDDI service registering machine is used for responding the calling message and acquiring the target service.

The core integrating module 16 is connected to the service interface 10, the database 12, and the UDDI service registering machine 14. The core integrating module 16 is used for accessing the service evaluation and the utility knowledge from the database 12 according to the calling message and generating the integrated information by integrating the service evaluation, the utility knowledge and the target service acquired by the UDDI service registering machine 14. Then, the integrated information is displayed on the service interface 10. Herewith the service user 2 can acquire the content of the integrated service through the service interface 10.

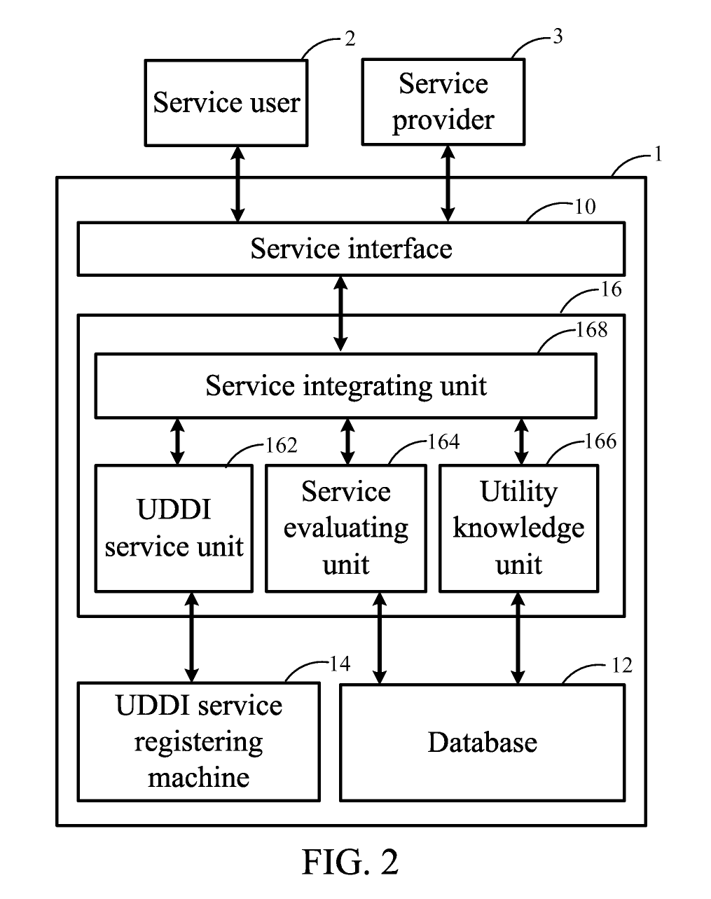

The core integrating module 16 can be further divided into several units with different functions respectively. As shown in FIG. 2, the core integrating module 16 can comprise a UDDI service unit 162, a service evaluating unit 164, a utility knowledge unit 166, and a service integrating unit 168.

The above-mentioned four units are described in detail respectively as follows.

The UDDI service unit 162 is connected to the UDDI service registering machine 14 and used for controlling the UDDI service registering machine to acquire the target service according to the calling message.

The service evaluating unit 164 is connected to the database 12 and used for accessing the service evaluation corresponding to the target service from the database 12 according to the calling message. That is to say, because the database 12 stores a lot of service evaluations corresponding to different services respectively, the function of the service evaluating unit 164 is to find out the service evaluation corresponding to the target service that the service user needs from the service evaluations.

The utility knowledge unit 166 is connected to the database 12 and used for accessing the utility knowledge from the database 12 according to the calling message. In detail, the function of the utility knowledge 166 is to find out the utility knowledge corresponding to the target service that the service user needs from the utility knowledge.

The service integrating unit 168 is connected to the service interface 10, the UDDI service unit 162, the service evaluating unit 164 and the utility knowledge unit 166. The service integrating unit 168 is used for receiving the calling message from the service interface 10 and generating the integrated information by integrating the target service acquired by the UDDI service unit 162, the service evaluation acquired by the service evaluating unit 164 and the utility knowledge acquired by the utility knowledge unit 166. Then, the integrated information is displayed on the service interface 10. Herewith the service user 2 can acquire the content of the integrated service through the service interface 10.

Next, the units of the core integrating module 16 will be described in detail respectively.

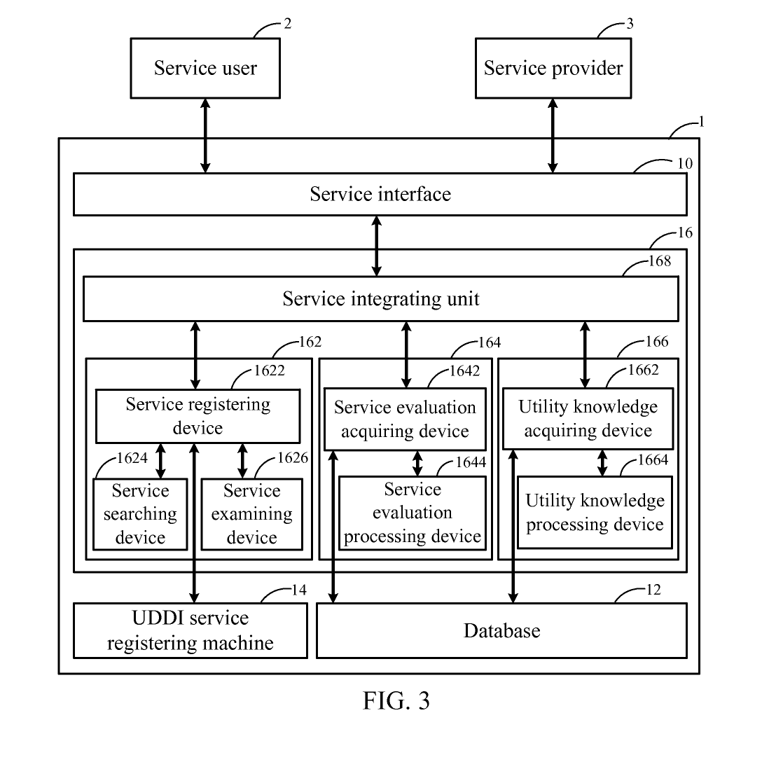

The first unit described here is the UDDI service unit 162. As shown in FIG. 3, the UDDI service unit 162 can comprise a service registering device 1622, a service searching device 1624, and a service examining device 1626.

The service registering device 1622 is connected to the UDDI service registering machine 14 and the service integrating unit 168, and used for controlling the UDDI service registering machine 14 to acquire the target service according to the calling message and transmit the target service to the service integrating unit 168.

The service searching device 1624 is connected to the service registering device 1622, and used for searching the target service from a plurality of services provided by the UDDI service registering machine 14 according to the calling message.

The service examining device 1626 is connected to the service registering device 1622, and used for examining the content of the target service.

Then, the service evaluating unit 164 of the core integrating module 16 is introduced. As shown in FIG. 3, the service evaluating unit 164 can comprise a service evaluation acquiring device 1642 and a service evaluation processing device 1644. The service evaluation acquiring device 1642 is connected to the database 12 and the service integrating unit 168, and used for accessing the service evaluation from the database 12 according to the calling message. The service evaluation processing device 1644 is connected to the service evaluation acquiring device 1642, and used for arranging and analyzing the service evaluation acquired by the service evaluation acquiring device 1642. Then, the service evaluation acquiring device 1642 will transmit the service evaluation processed by the service evaluation processing device 1644 to the service integrating unit 168.

Afterward, the utility knowledge unit 166 of the core integrating module 16 is introduced. As shown in FIG. 3, the utility knowledge unit 166 comprises a utility knowledge acquiring device 1662 and a utility knowledge processing device 1664. The utility knowledge acquiring device 1662 is connected to the database 12 and the service integrating unit 168, and used for accessing the utility knowledge from the database 12 according to the calling message. The utility knowledge processing device 1664 is connected to the utility knowledge acquiring device 1662, and used for arranging and analyzing the utility knowledge acquired by the utility knowledge acquiring device 1662. The utility knowledge acquiring device 1662 will transmit the utility knowledge processed by the utility knowledge processing device 1664 to the service integrating unit 168.

The web service registering system according to the invention has a function of providing utility knowledge. Thus, when a service user wants to use a service, the using experience related to the service collected by the web service registering system can be referred to help the user use the service correctly and promptly. After the user uses the service, the utility knowledge provided by the user can also be collected and arranged by the web service registering system.

In this invention, the utility knowledge which can help the user use the service correctly can be divided into the following three types: text knowledge, keyword knowledge, and teaching film knowledge. These three types of utility knowledge are introduced as follows.

The first type of utility knowledge is the text knowledge. As implied by the name, the text knowledge shows the content of utility knowledge by the form of text. For example, the text knowledge can be the personal using experience or the example of programming codes, and can be stored or displayed in the form of HTML.

The second type of utility knowledge is the teaching film knowledge. The teaching film knowledge is recorded in a multimedia way. In the invention, the web service registering system can combine the famous Youtube (the web address is www.youtube.com) web system to record the teaching film knowledge by recording its Youtube ID. In the above-mentioned information, the web service registering system connects the utility knowledge with various kinds of services by recording UUID.

The third type of utility knowledge is the keyword knowledge. Different service users can define suitable keywords for different services respectively. Thus, the web service registering system can fully use the massed intelligence related to the service classification by collecting the keywords defined by different service users.

The advantage of the keyword knowledge is to classify the services more accurately and help other potential users know the correct orientation and cognition toward the service. In order to reach the function of multiple keyword collection, the invention uses two tables to record the keyword and the connection of the keyword and the UUID. The following is an example.

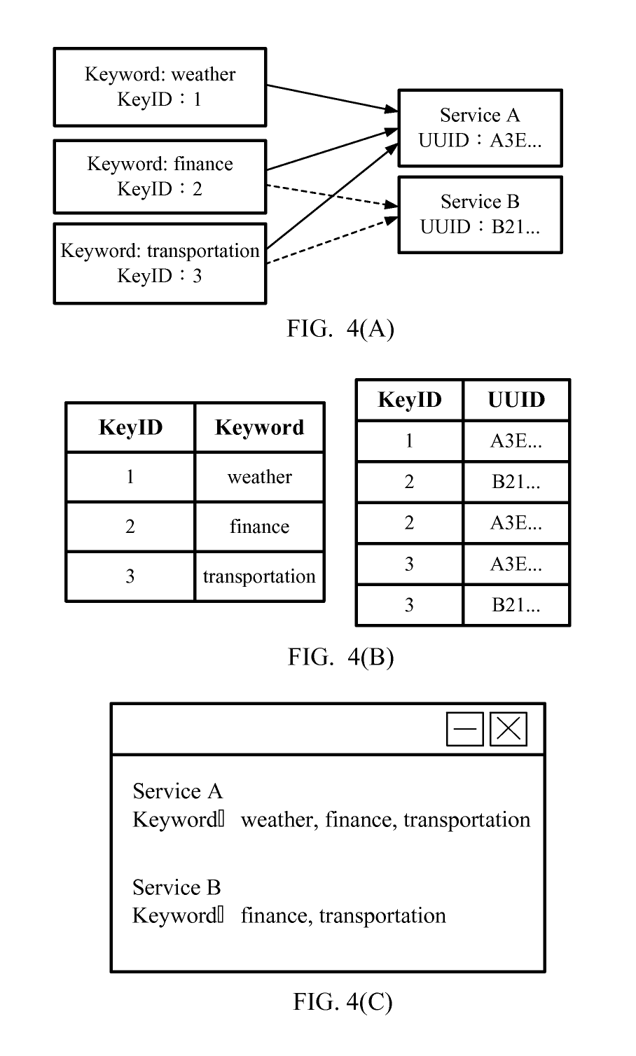

In the example, three keywords (weather, finance, and transportation) and two services (service A and service B) are shown. The connection between the keywords and the services are shown in FIG. 4(A). Each of the keywords has a KeyID, and each of the services has a UUID (the above-mentioned UDDI architecture can be referred to).

Every time the service user provides a keyword, then the connection between the keyword and the service will be established. Thus, after the user provides keywords many times, the service A and the service B will accumulate a lot of keyword knowledge respectively. In order to effectively collect the keyword knowledge, two tables are used in the invention for recording the KeyID of the keyword and the connection between the KeyID and the UUID respectively. As shown in FIG. 4(B), the direct processing way of recording the keyword and UUID is not used, so that the access efficiency of the information architecture can be improved.

This method can prevent the double definition of the KeyID related to the keyword to save the space effectively. In addition, when the new keyword is collected every time, only the connection between the KeyID and the UUID is needed to be recorded. Therefore, the keywords can be elastically increased. In addition, when the user wants to reversely enquire certain keyword (e.g., finance), he/she can also find out the services (e.g., service A and service B) related to the keyword by searching this connection.

As shown in FIG. 4(C), the service interface will show service A and service B, and the keywords corresponding to service A and service B respectively.

At last, when the service evaluation acquiring device 1642 and the utility knowledge acquiring device 1662 transmit the processed service evaluation and utility knowledge to the service integrating unit 168, the service integrating unit 168 will integrate these service evaluation and utility knowledge into the target service transmitted by the UDDI service unit, and the integrated service content will be displayed on the service interface 10 to provide the reference for the service user.

In addition, the web service registering system according to the invention can also be used for analyzing the connection between the service user and the service he/she used. The following shows an example.

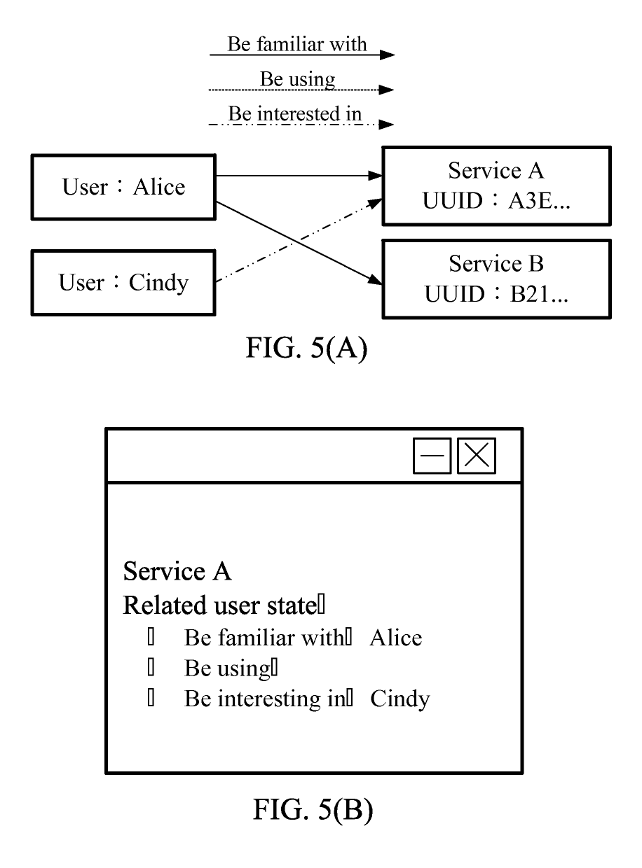

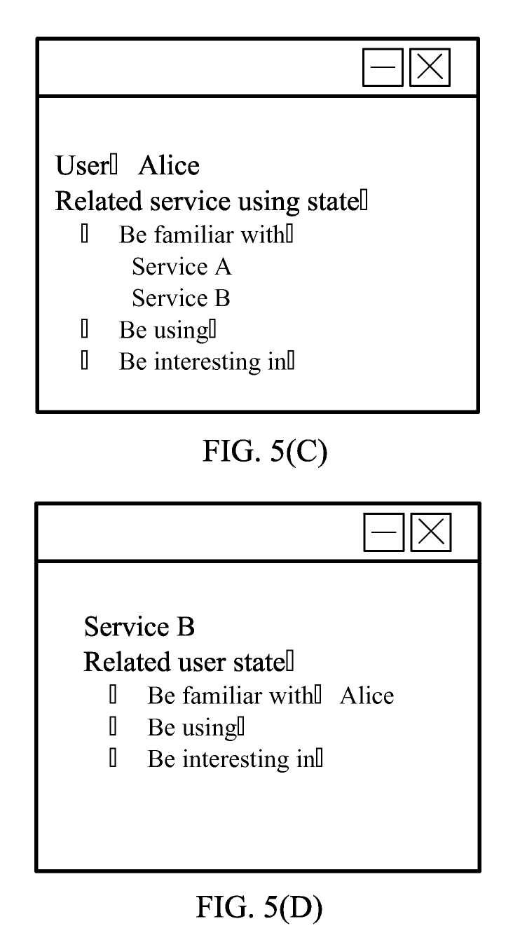

As shown in FIG. 5(A), the connection between the service users Alice/Cindy and the services A/B is displayed on the service interface. The service user Alice is familiar with the service A and the service B, and the service user Cindy is interested in the service A. As shown in FIG. 5(B), the state of the user related to the service A is displayed on the service interface. For the service A, the familiar user is Alice, and the interested user is Cindy. As shown in FIG. 5(C), the service using state related to the service user Alice is displayed on the service interface. In fact, the service interface shown in FIG. 5(C) can be obtained by clicking the service user Alice displayed on the service interface shown in FIG. 5(B). For the service user Alice, the familiar services are the service A and the service B. As shown in FIG. 5(D), the state of the user related to the service B is displayed on the service interface. In fact, the service interface shown in FIG. 5(D) can be obtained by clicking the service B displayed on the service interface shown in FIG. 5(C). As shown in FIG. 5(D), for the service B, the familiar user is Alice.

Accordingly, the web service registering system according to the invention can acquire the service using state corresponding to certain a service user or the state of the user corresponding to certain a service by analyzing the connection between the service user and the service. By doing so, the web service registering system can further calculate and analyze the behavior modes or preferences when the various services are used by different service users respectively.

Compared to the prior art, the web service registering system according to the invention has the functions of service evaluation and utility knowledge. Thus, the service user can acquire the needed service information via the web service registering system. When the user wants to select service, the service evaluation provided by the web service registering system according to the invention can be used for selecting a better service from the various services. In addition, the service user can use the service quickly and smoothly with the help of utility knowledge provided by the web service registering system.

With the recitations of the preferred embodiment above, the features and spirits of the invention will be hopefully well described. However, the scope of the invention is not restricted by the preferred embodiment disclosed above. The objective is that all alternative and equivalent arrangements are hopefully covered in the scope of the appended claims of the invention. Accordingly, the above disclosure should be construed as limited only by the metes and bounds of the appended claims.

What is claimed is:

1. A web service registering system with service evaluation and utility knowledge, comprising:
a service interface for generating a calling message corresponding to a target service provided by a service provider;
a database for storing a service evaluation and a utility knowledge corresponding to the target service;
a UDDI (Universal Description, Discovery and Integration) service registering machine for registering toward the service provider to acquire the target service based on the calling message; and
a core integrating module for integrating the service evaluation and the utility knowledge accessed from the database and the target service accessed from the UDDI service registering machine according to the calling message to generate an integrated information and displaying the integrated information on the service interface.

2. The web service registering system of claim 1, wherein the core integrating module comprises:
a UDDI service unit, connected to the UDDI service registering machine, for controlling the UDDI service registering machine to register toward the service provider according to the calling message and acquire the target service;
a service evaluating unit, connected to the database, for accessing the service evaluation from the database according to the calling message;
a utility knowledge unit, connected to the database, for accessing the utility knowledge from the database according to the calling message; and
a service integrating unit, connected to the service interface, the UDDI service unit, the service evaluating unit and the utility knowledge unit, for receiving the calling message from the service interface and generating the integrated information by integrating the target service, the service evaluation and the utility knowledge, then transmitting the integrated information to the service interface.

3. The web service registering system of claim 2, wherein the UDDI service unit comprises:
a service registering device, connected to the UDDI service registering machine and the service integrating unit, for controlling the UDDI service registering machine to register toward the service provider according to the calling message and transmitting the target service to the service integrating unit;
a service searching device, connected to the service registering device, for searching the target service from a plurality of services provided by the service provider according to the calling message; and
a service examining device, connected to the service registering device, for examining the content of the target service.

4. The web service registering system of claim 2, wherein the service evaluating unit comprises:
a service evaluation acquiring device, connected to the database and the service integrating unit, for accessing the service evaluation from the database according to the calling message; and
a service evaluation processing device, connected to the service evaluation acquiring device, for arranging and analyzing the service evaluation, the service evaluation acquiring device transmitting the service evaluation to the service integrating unit.

5. The web service registering system of claim 2, wherein the utility knowledge unit comprises:
a utility knowledge acquiring device, connected to the database and the service integrating unit, for accessing the utility knowledge from the database according to the calling message; and
a utility knowledge processing device, connected to the utility knowledge acquiring device, for arranging and analyzing the utility knowledge, the utility knowledge acquiring device transmitting the utility knowledge to the service integrating unit.
